(19) United States
(12) Patent Application Publication
(10) Pub. No.: US 2007/0053324 A1
(43) Pub. Date: Mar. 8, 2007

(54) Apparatus and method for collecting traffic information using ultra wideband impulse, and system and method for controlling traffic sign using the same

(76) Inventor: In-Kwan Hwang, DAE-JEON (KR)

Correspondence Address: VENABLE LLP, P.O. BOX 34385, WASHINGTON, DC, 20043-9998, US

(21) Appl. No.: 10/556,556

(22) PCT Filed: May 12, 2004
(86) PCT No.: PCT/KR04/01098

§ 371 Date: Nov. 14, 2005

(30) Foreign Application Priority Data
May 12, 2003 (KR) 10-2003-0029876

(51) Int. Cl. H04B 7/216

(52) U.S. Cl. 370/335

(57) ABSTRACT

Provided are a traffic information collecting/managing apparatus using ultra wideband impulse, a method thereof, a traffic light control system using the method and a method therefor. The traffic information collecting/managing apparatus includes: a primary wireless communication unit for assigning channels upon receipt of a channel assignment request from a terminal installed in a vehicle, computing location information and speed information, which will be referred to as traffic information, based on time by using ultra wideband impulse response signals transmitted from the terminal and a plurality of secondary wireless communication means, and Transmitting the traffic information to a traffic control server, the wireless communication means for transmitting the ultra wideband impulse response signals transmitted from the terminal to the primary wireless communication unit; and the traffic control server for managing the traffic information transmitted from the primary wireless communication unit in a database so that the traffic information can be applied to traffic-related systems.

### TECHNICAL FIELD

The present invention relates to an apparatus and method for collecting/managing traffic information using ultra wideband impulse, and system and method for controlling traffic lights using the same; and, more particularly, to a traffic information collecting/managing apparatus that can collect highly precise traffic information from terminals installed in vehicles on roads by using ultra wideband impulse, and manage the traffic information in a database so that the traffic information can be applied to diverse application systems, a method thereof, and system and method for controlling traffic lights by using the traffic information collected by the traffic information collecting/managing apparatus.

### BACKGROUND ART

Generally, there are traffic lights for pedestrians which control the passage of pedestrians and traffic lights for vehicles which control the passage of vehicles on, a crossroad or a crosswalk.

The traffic lights operate according to the control of a traffic lights controller, which basically controls the traffic lights sequentially based on a pre-established pattern and, when one period is ended, it goes back to the beginning of the pattern and controls the traffic lights in the same control pattern of the previous period.

For example, if a traffic light for drivers displays a pass sign on a two-way road, a traffic light for pedestrians displays a stop sign. Otherwise, if the traffic light for drivers displays a stop sign, the traffic light for pedestrians displays a pass sign. Of course, the traffic light for drivers also displays a passage standby sign other than the pass and stop signs.

General methods of controlling traffic lights on crossroads may be a little complicated but basically they are similar to methods of controlling traffic lights on a two-way road. That is, if a traffic light for drivers on one way displays a pass sign, traffic lights for drivers in the forward and left-turn directions of the other way and traffic lights for pedestrians all display a stop-driving sign and a do-not-walk sign. Here, a traffic light for drivers in the right-turn direction of the vehicles displays a stop sign and the traffic light for pedestrians in the right-turn direction of the vehicles displays a walk sign and allows pedestrians to cross the road.

It is important that traffic lights performing above described functions should cooperate with adjacent traffic light controllers, which means that a flow of traffic is guaranteed for a green light consecutively without being blocked by a red light when it arrives at adjacent crossroads maintaining an average speed from previous crossroads.

Therefore, large cities have a traffic control center and connect a host computer installed in the traffic control center with traffic light controllers of crossroads through communication wires to thereby maintain smooth traffic in the entire city.

Meanwhile, in specific cases, an agent may manually operate a traffic light controller set up around traffic lights of crossroads and change a signal system. Here, the specific cases include when traffic congestion occurs in one direction, when traffic is controlled due to a ceremonial event on the roads, and when a vehicle accommodating a Very Important Person (VIP) passes through the road.

The traffic light controllers have a problem that it is hard to take measures for smooth traffic quickly when such events occur.

To solve this problem, a conventional technology suggests a method of controlling traffic lights in connection with a traffic light controller by installing a loop detector at specific locations, checking whether vehicles pass or not, and measuring speed. However, the method has a problem that characteristic information of a passing vehicle is not obtained because no communication is carried out with the passing vehicle.

As another conventional technology, there is a Dedicated Short Range Communication system, a communication system which collects characteristic information of a vehicle and speed information from a wireless terminal set up in the vehicle and controls traffic lights in connection with a traffic light controller.

However, the Dedicated Short Range Communication system cannot detect a precise location of a passing vehicle and it takes a lot of money to establish the system because it is a high-speed data communication system.

Yet another prior art suggests a method of taking a picture of a traffic flow by using a camera and controlling traffic lights in connection with a traffic light controller. This method also has a problem that characteristic information of a vehicle cannot be obtained because no communication is carried out with the vehicle.

Still another prior art suggests a method of collecting characteristic information of a vehicle and speed information by using Radio Frequency Identification (RFID) and controlling traffic lights in connection with a traffic light controller. This method cannot obtain precise location information but confirm only the presence of a vehicle within the communication coverage of an RFID reader.

### DISCLOSURE OF INVENTION

It is, therefore, an object of the present invention to provide a traffic information collecting/managing apparatus that can collect highly precise traffic information from terminals installed in vehicles on roads by using ultra wideband impulse, and manage the traffic information in a database so that the traffic information can be applied to diverse application systems, and a method thereof.

It is another object of the present invention to provide a system and method for controlling traffic lights by using the traffic information collected by the traffic information collecting/managing apparatus to control traffic flow quickly and smoothly.

In accordance with one aspect of the present invention, there is provided an apparatus for collecting/managing traffic information by using ultra wideband impulse, including: a primary wireless communication unit for assigning channels upon a channel assignment request from a terminal installed in a vehicle, computing location information and speed information, which will be referred to as traffic information, based on time by using a ultra wideband impulse response signal which is transmitted from the terminal installed in the vehicle and ultra wideband impulse response signals which are transmitted from a plurality of secondary wireless communication units, and transmitting the computed traffic information to a traffic control server; the multiple number of secondary wireless communication units for transmitting the ultra wideband impulse response signals, which are transmitted from the terminal installed in the vehicle, to the primary wireless communication unit; and the traffic control server for managing the traffic information transmitted from the primary wireless communication unit in a database so that the traffic information can be applied to traffic-related systems. Hereafter, in the present invention, the ultra wideband impulse response signal is referred to as the shaped pulse signal which is the output of the shaped pulse generator and is corresponding to the peak correlation instant of the received ultra impulse signal.

In accordance with another aspect of the present invention, there is provided a method for collecting/managing traffic information by using ultra wideband impulse, including the steps of: assigning channels upon a channel assignment request from a terminal installed in a vehicle; receiving a ultra wideband impulse signal from the terminal installed in the vehicle;

computing location information and speed information, which will be referred to as traffic information, based on time by using the ultra wideband impulse response signal; and managing the traffic information in a database so that the traffic information can be applied to traffic-related systems.

In accordance with another aspect of the present invention, there is provided a system for controlling traffic lights by using traffic information, including: a primary wireless communication unit for assigning channels upon a channel assignment request from a terminal installed in a vehicle, computing location information and speed information, which will be referred to as traffic information, based on time by using a ultra wideband impulse response signal which is transmitted from the terminal installed in the vehicle and ultra wideband impulse response signals which are transmitted from a plurality of secondary wireless communication units, and transmitting the computed traffic information to a traffic control unit; the multiple number of secondary wireless communication units for transmitting the ultra wideband impulse response signals, which are transmitted from the terminal installed in the vehicle, to the primary wireless communication unit; and the traffic control unit for controlling a traffic light based on the traffic information transmitted from the primary wireless communication unit.

In accordance with another aspect of the present invention, there is provided a method for controlling traffic lights using traffic information, including the steps of: assigning channels upon receipt of a channel assignment request from a terminal installed in a vehicle; receiving a ultra wideband impulse response signal from the terminal installed in the vehicle; computing location information and speed information, which will be referred to as traffic information, based on time by using the ultra wideband impulse response signal; and controlling traffic lights by using the traffic information.

In accordance with another aspect of the present invention, traffic lights can be controlled efficiently for smooth traffic by using ultra wideband impulse signals and measuring location and speed of vehicles precisely in real-time.

In accordance with another aspect of the present invention, highly precise location information of a vehicle can be obtained using ultra wideband impulse signals and used for diverse application fields using the vehicle location information.

The system of the present invention can be embodied in a form of an inexpensive small system and installed in all kinds of vehicles easily.

The present invention utilizes a Code Division Multiple Access (CDMA) method using ultra wideband impulse signals which are spread by pseudo noise (PN) codes to measure location and speed information of vehicles quickly, but the CDMA method is combined with Time Division Multiple Access (TDMA) method and Time Division Duplex (TDD) method to minimize interference on the other service systems.

### BRIEF DESCRIPTION OF DRAWINGS

The above and other objects and features of the present invention will become apparent from the following description of the preferred embodiments given in conjunction with the accompanying drawings, in which:

FIG. 1 is a diagram showing a traffic information collecting/managing apparatus using ultra wideband impulse and a traffic light control system in accordance with an embodiment of the present invention;

FIG. 2 is a detailed front view of a traffic information collecting/managing apparatus using ultra wideband impulse and a traffic light control system in accordance with an embodiment of the present invention;

FIG. 3 is a detailed side view of a traffic information collecting/managing apparatus using ultra wideband impulse and a traffic light control system in accordance with an embodiment of the present invention;

FIG. 4 is a diagram illustrating an ultra wideband impulse signal used for the collection of traffic information in a traffic information collecting/managing apparatus in accordance with an embodiment of the present invention;

FIG. 5 is a flowchart describing a traffic information collecting method in a traffic information collecting/managing apparatus in accordance with an embodiment of the present invention;

FIG. 6 is a block diagram showing a primary station in accordance with an embodiment of the present invention;

FIG. 7 is a block diagram showing a secondary station in accordance with an embodiment of the present invention;

FIG. 8 is a block diagram showing a terminal installed in a vehicle in accordance with an embodiment of the present invention; and

FIG. 9 is a diagram illustrating a structure of Time Division Multiple Access (TDMA) and Time Division Duplex (TDD) scheme in accordance with an embodiment of the present invention.

### BEST MODE FOR CARRYING OUT THE INVENTION

Other objects and aspects of the invention will become apparent from the following description of the embodiments with reference to the accompanying drawings, which is set forth hereinafter.

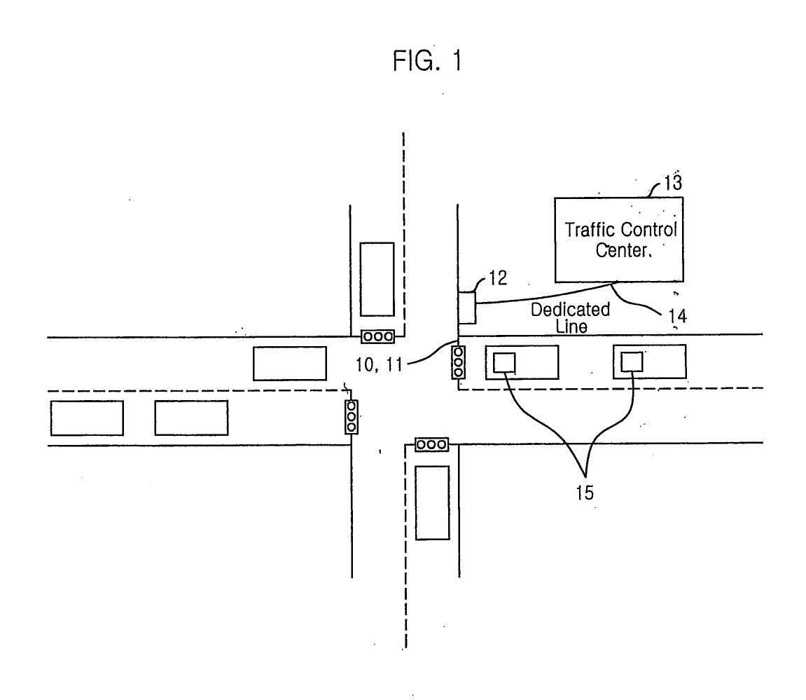

FIG. 1 is a diagram showing a traffic information collecting/managing apparatus using ultra wideband impulse and a traffic light control system in accordance with an embodiment of the present invention.

As shown in FIG. 1, the traffic information collecting/managing apparatus using ultra wideband impulse includes a primary station (central wireless communication portion) 11, a plurality of secondary stations 10, and a traffic control center 13 and it collects highly precise traffic information from a terminal 15 installed in a vehicle by using ultra wideband impulse at a certain location of a traffic light post. Also, it manages the traffic information in a database so that the collected traffic information could be applied to diverse application systems.

Here, the diverse application systems include systems performing real-time traffic light control for smooth traffic flow, performing real-time control of variable traffic lanes, carrying out quick traffic control for emergency vehicles such as fire trucks, rescue vehicles and ambulance, detecting auto collision accidents, providing information for rapid life rescue and investigating causes of an accident, watching if no-car-once-every-10-days system is violated, detecting drunken driving car based on real-time location information of a vehicle, tracking a stolen car or a car driven by a criminal, performing automatic toll collection, performing automatic parking management, and carrying out statistic traffic analysis by building a traffic database.

In addition, the traffic light controlling system of the present invention controls traffic lights for quick and smooth traffic flow by using traffic information collected by the traffic information collecting/managing apparatus.

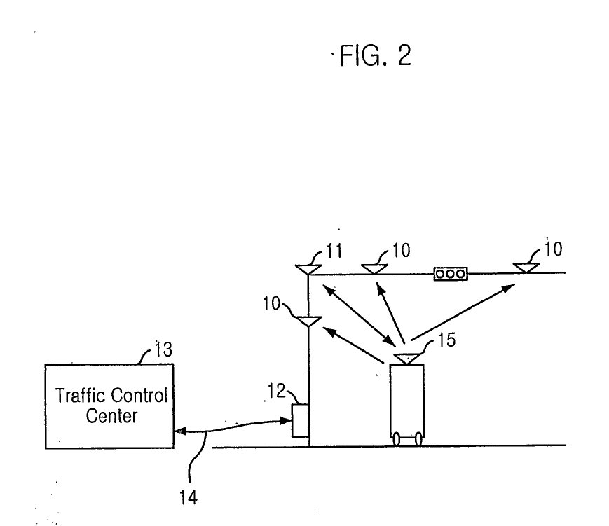

FIG. 2 is a detailed diagram showing a traffic information collecting/managing apparatus using ultra wideband impulse and a traffic light control system in accordance with an embodiment of the present invention. The traffic information collecting/managing apparatus includes a primary station 11, a plurality of secondary stations 10, and a traffic control center 13. The primary station 11 computes time-based location information and speed information of vehicles in real-time based on ultra wideband impulse response signals transmitted from a plurality of terminals 15 installed in vehicles and ultra wideband impulse response signals transmitted from the secondary stations 10, as it assigns channels upon a channel assignment request from the terminals 15 installed in vehicles, and it transmits the obtained location information and speed information, i.e., traffic information, to the traffic control center 13 so that the traffic information can be applied to diverse application systems. The secondary stations 10 transmit the ultra wideband impulse response signals from the terminals 15 installed in vehicles to the primary station 11. The traffic control center 13 manages the traffic information through statistic process and a database so that the traffic information transmitted from the primary station 11 can be applied to diverse systems.

Also, a traffic light control system using the b traffic information includes a primary station 11, a plurality of secondary stations 10, a traffic control center 13, a traffic light controller 12, and dedicated lines 14. The primary station 11 computes time-based location information and speed information of vehicles in real-time based on ultra wideband impulse response signals transmitted from a plurality of terminals 15 installed in vehicles and ultra wideband impulse response signals transmitted from the secondary stations 10, as it assigns channels upon a channel assignment request from the terminals 15 installed in vehicles, and it transmits the obtained location information and speed information, i.e., traffic information, to the traffic control center 13 so that the traffic information can be applied to diverse application systems or transmit it to the traffic control center 13 so that it can be used for controlling traffic lights. The secondary stations 10 transmit the ultra wideband impulse response signals from the terminals 15 installed in vehicles to the primary station 11. The traffic control center 13 manages the traffic information in a database so that the traffic information transmitted from the primary station 11 can be applied to diverse systems and transmit the traffic information to the traffic light controller 12 so that it can be used for controlling traffic lights. The traffic light controller 12 receives the traffic information from the primary station 11 or traffic control center 13 and controls traffic lights. The dedicated lines 14 connect the traffic light controller 12 with the traffic control center 13.

Here, the characteristic information includes vehicle number, owner of vehicle, and kind of vehicle.

In addition, the primary station 11 and the three secondary stations 10 communicate with an approaching vehicle independently in a predetermined communication area to reduce complexity of a traffic light control system.

Meanwhile, the process of computing traffic information in the traffic information collecting/managing apparatus will be described hereafter.

First, as channels are assigned upon the channel assignment request from a terminal 15 installed in a vehicle, the primary station 11 and the secondary stations 10 receive ultra wideband impulse response signals. Here, the primary station 11 and the secondary stations 10 have the same communication coverage. Also, since the primary station 11 and the secondary stations 10 receive the ultra wideband impulse signals at different locations around the terminal 15 installed in the vehicle, different delays in receiving time occur.

Subsequently, the secondary stations 10 transmit the ultra wideband impulse response signals from the terminals 15 installed in vehicles to the primary station 11.

Subsequently, the primary station 11 computes traffic information of the vehicle having the terminal 15 based on the ultra wideband impulse response signals transmitted from the terminal 15 and the ultra wideband impulse response signals transmitted from the secondary stations 10.

Then, the primary station 11 can transmit the obtained traffic information to the traffic control center 13 where the traffic information can be applied to diverse application systems.

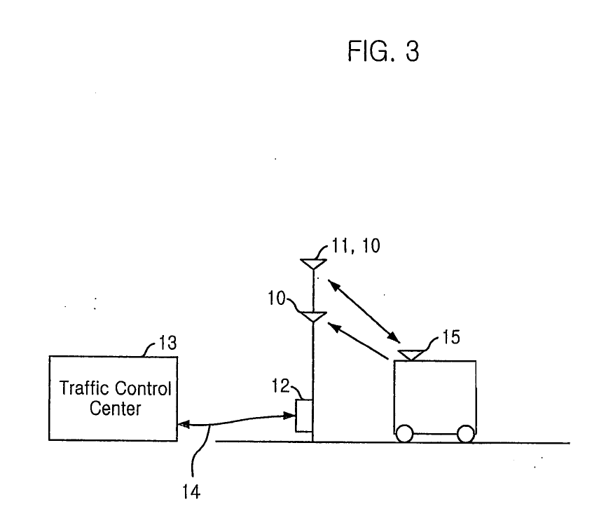

FIG. 3 is a detailed diagram showing a traffic information collecting/managing apparatus using ultra wideband impulse and a traffic light control system in accordance with an embodiment of the present invention.

As shown in FIG. 3, the secondary stations 10 are installed in different heights and locations based on the primary station 11. This is because the system needs delay in receiving time to compute location information and speed information. Here, the primary station 11 has a positioning algorithm for positioning the vehicle based on the receiving delay time at each of the secondary stations. Since the positioning algorithm is widely known, no further description will be made herein.

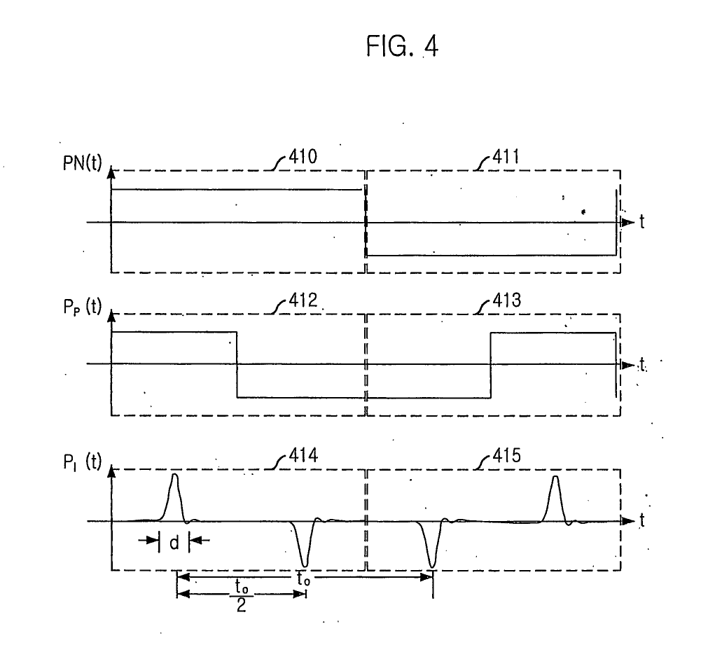

FIG. 4 is a diagram illustrating an ultra wideband impulse signal used for the collection of traffic information in a traffic information collecting/managing apparatus in accordance with an embodiment of the present invention.

As shown in FIG. 4, the ultra wideband impulse signals are baseband signals which are transmitted/received between the terminal 15 installed in a vehicle and the primary station 11 and the secondary stations 10 to position the terminal 15 installed in a vehicle. PN(t) graph shows ‘1’ 410 and ‘0’ 411 of a Pseudo-Noise (PN) spreading codes, and P_{P}(t) shows output signals ‘1’ 412 and ‘0’ 413 of a pulse generator which are necessary to generate impulse doublets, while P_{I}(t) shows output signals ‘1’ 414 and ‘0’ 415 of an impulse generator which are transmitted from the terminal 15 installed in the vehicle to the primary station 11 and the secondary station 10. Here, it is desirable to establish the width (d) of an impulse signal to be no wider than 0.1 ns and time (t₀) around 10 ns to perform positioning with preciseness of no more than 3 cm.

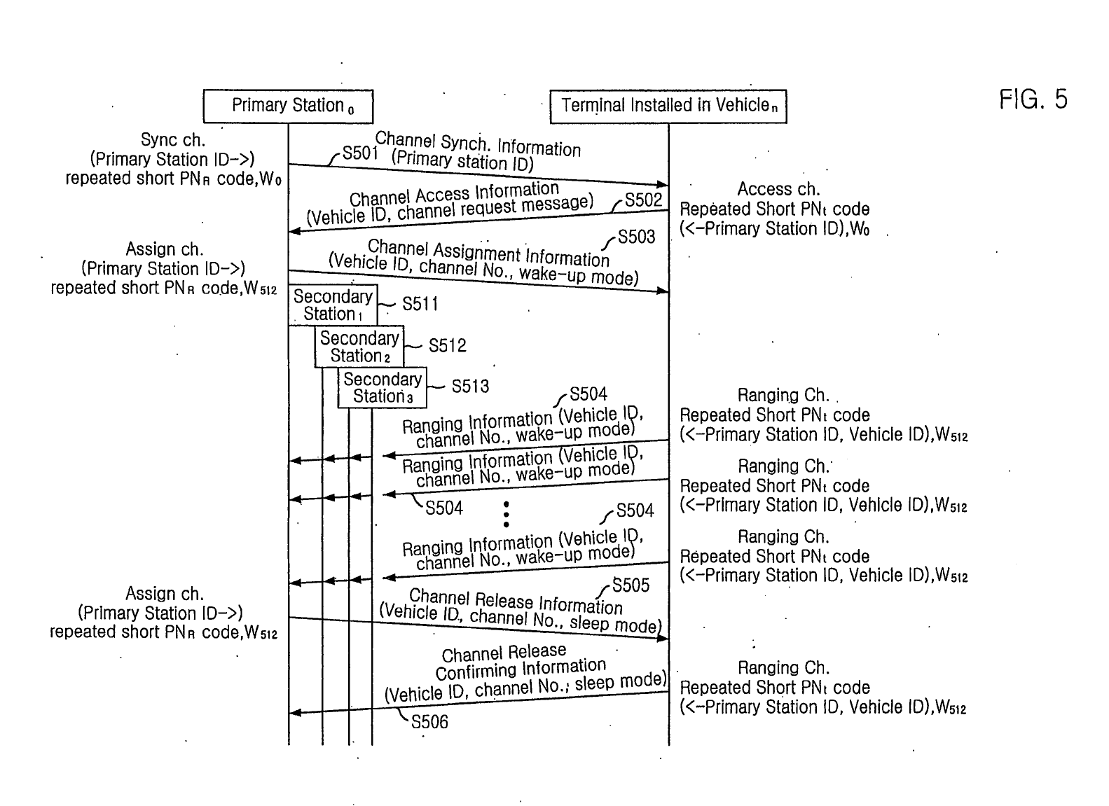

FIG. 5 is a flowchart describing a traffic information collecting method in a traffic information collecting/managing apparatus in accordance with an embodiment of the present invention.

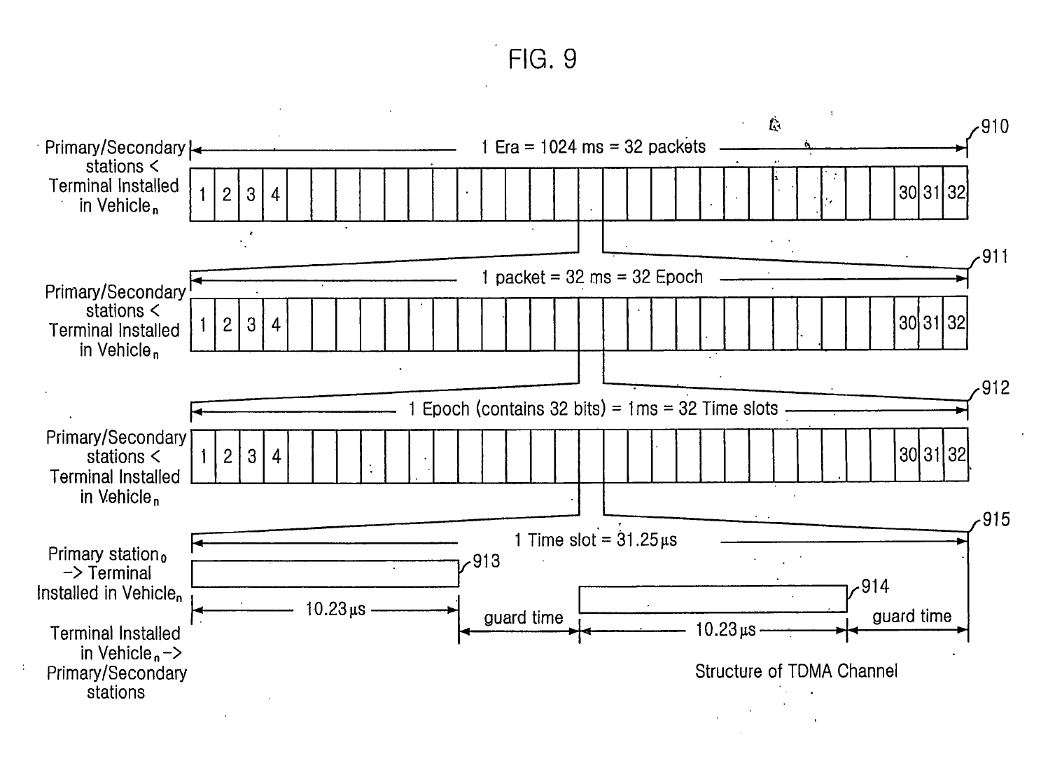

First, at step S501, the primary station 11 transmits channel synchronization information (ID of the primary station) which is spread by a PN_{R} code (or repeated short PN_{R} code) which is obtained by performing phase offset-based on an identifying number (ID) of the primary station 11 and a Walsh code W_{O}, to the terminal 15 installed in the vehicle in 1 time slot, as illustrated in FIG. 9.

Then, the terminal 15 installed in the vehicle detects the transmitted channel synchronization information, as the vehicle having- the terminal 15 installed therein enters the communication coverage. At step S502, the terminal transmits channel access information (vehicle ID and channel request message) which is spread by a PNₜ code (or repeated short PNₜ code) which is obtained by performing phase offset based on the ID of the primary station 11 and a Walsh code W_{O}, to the primary station 11 in 1 time slot, as illustrated in FIG. 9.

Then, at step S503, after the primary station 11 detects the received channel access information, transmits channel assignment information (vehicle ID, channel No., and wake-up mode) which is spread by a reference PN code PN_{R} (which is referred to as “PN_{R}” hereinafter) (or repeated short PN_{R} code) which is obtained by performing phase offset based on the ID of the primary station 11 and a Walsh code W₅₁₂, to the terminal 15 installed in the vehicle in 1 time slot, as illustrated in FIG. 9.

Subsequently, the terminal 15 installed in the vehicle detects the transmitted channel assignment information and, at step S504, transmits ranging information (vehicle ID, channel No., and wake-up mode) which is spread by a PN code PNₜ (which is referred to as “PNₜ” hereinafter) (or repeated short PNₜ code) which is obtained by performing phase offset based on the IDs of the primary station 11 and the vehicle and a Walsh code W₅₁₂, to the primary station 11 and the secondary stations 10 in 1 time slot, as illustrated in FIG. 9.

Then, the primary station 11 computes traffic information (time-based location information and speed information of a vehicle) of the vehicle having the terminal- 15 by using the ultra wideband impulse response signals transmitted from the terminal 15 installed in the vehicle and the ultra wideband impulse response signals transmitted from the secondary stations 10. If the traffic information is to be applied to a traffic light control system, the primary station 11 transmits the obtained traffic information to the traffic light controller 12.

Due to the use of ultra wideband impulse signals, the above process is carried out within a very short time. Precise traffic information can be collected in a short time by repeating the above process periodically.

Subsequently, at step S505, if the vehicle having the terminal 15 reaches a threshold value, the primary station 11 transmits channel release information (vehicle ID, channel No. and sleep mode) which is spread by a PN_{R} code (or repeated short PN_{R} code) which is obtained by performing phase offset based on the ID of the primary station 11 and a Walsh code W₅₁₂ to the terminal 15 installed in the vehicle in 1 time slot, as illustrated in FIG. 9. Here, the threshold indicates a location value right before the vehicle having the terminal 15 gets out of the communication coverage of the primary station 11.

Then, at step S506, the terminal 15 installed in the vehicle detects the transmitted channel release information and transmits channel release confirming information (vehicle ID, channel No., and sleep mode) which is spread by a PNₜ code (or repeated short PNₜ code) which is obtained by performing phase offset based on the IDs of the primary station 11 and the vehicle and a Walsh code W₅₁₂, to primary station 11 in 1 time slot, as illustrated in FIG. 9.

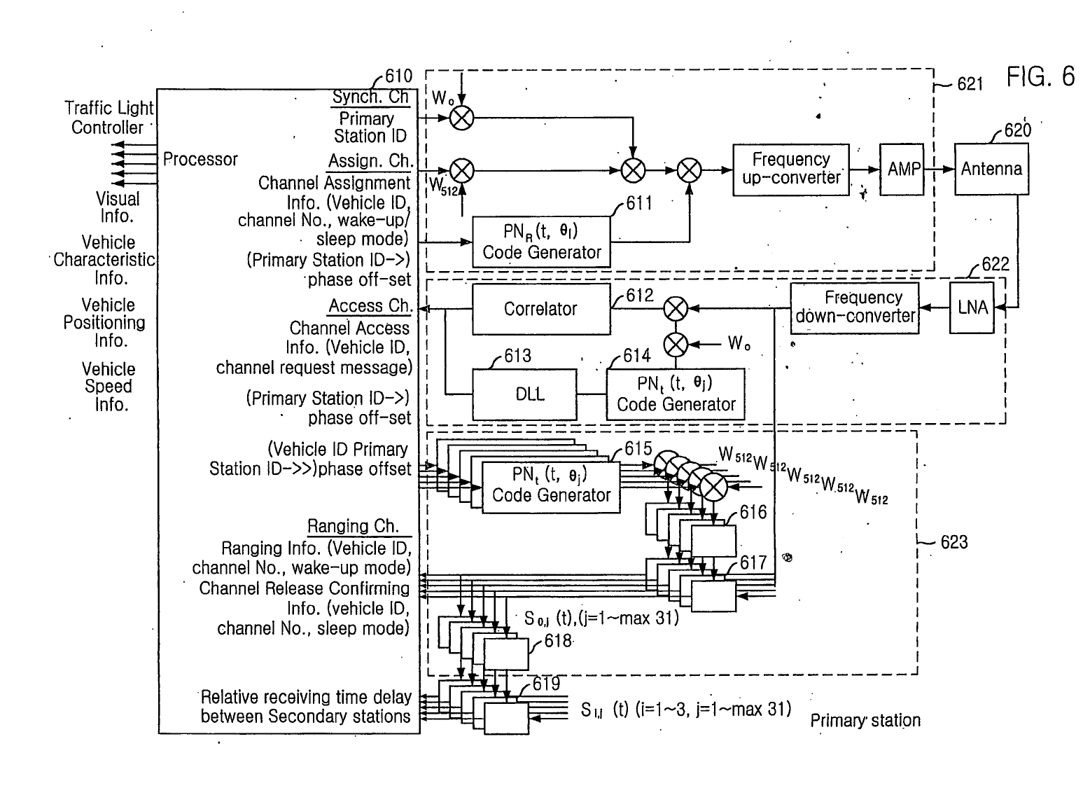

FIG. 6 is a block diagram showing a primary station in accordance with an embodiment of the present invention.

As shown in FIG. 6, the primary station of the present invention includes following elements.

First, an information transmitting unit 621 transmits channel synchronization information (ID of the primary station) which is spread by a PN_{R} code (or a repeated short PN_{R} code) which is obtained by performing phase offset based on the ID of the primary station 11 and a Walsh code W₀, to the terminal 15 installed in the vehicle in 1 time slot.

Also, the information transmitting unit 621 transmits channel assignment information (vehicle ID, channel No., and wake-up mode) which is spread by a PN_{R} code (or a repeated short PN_{R} code) which is obtained by performing phase offset based on the ID of the primary station 11 and a Walsh code W₅₁₂, to the terminal 15 installed in the vehicle in 1 time slot.

Also, it transmits channel release information (vehicle ID, channel No., and sleep mode) which is spread by a PN_{R} code (or a repeated short PN_{R} code) which is obtained by performing phase offset based on the IDs of the primary station 11 and vehicle ID, and a Walsh code W₅₁₂, to the terminal 15 installed in the vehicle in 1 time slot.

Here, a PN_{R}(t, θᵢ) code generator (a repeated short PN_{R}(t, θ₁) code generator) 611 generates a spreading code obtained by performing phase (θᵢ) offset based on the ID of the primary station 11 (or obtained from repetition of code length, i.e., 31, 33 times.

Also, an antenna 620 should be a directional antenna, desirably. However, for a parking management system an isotropic antenna is more adequate.

A channel access information receiving unit 622 receives channel access information (vehicle ID and channel request message) which is spread by a PNₜ code (a repeated short PNₜ code) which is obtained by performing phase offset based on the ID of the primary station 11 and a Walsh code W₀, from the terminal 15 installed in the vehicle in 1 time slot.

Here, the correlator 612, a delay lock loop (DLL) 613 and the PNₜ(t, θⱼ) code generator 614 are synchronized based on the received code PNₜ. Also, the PNₜ(t, θⱼ) code generator 614 is initialized by using an ID of the primary station 11.

A ranging information receiving unit 623 receives ranging information (vehicle ID, channel No., and wake-up mode) which is spread by a PNₜ code (or a repeated short PNₜ code) which is obtained by performing phase offset based on the IDs of the primary station 11 and the vehicle, and a Walsh code W₅₁₂, from the terminal 15 installed in the vehicle in 1 time slot.

Also, it receives channel-release confirming information (vehicle ID, channel No., and sleep mode) which is spread by a PNₜ code (or a repeated short PNₜ code) which is obtained by performing phase offset by the IDs of the primary station 11 and the vehicle, and a Walsh code W₅₁₂, from the terminal 15 installed in the vehicle in 1 time slot.

Here, a pulse generator 616 generates pulse signals by using the PNₜ(t, θⱼ) code generator 615 (hereinafter, which is referred to as PNₜ code generator, t being time and θᵢ being phase offset) and a Walsh code W₅₁₂, and a pulse shaper 618 generates a pulse signal S_{0,j}(t) by extracting time where the output of a time integration correlator 617 is the maximum.

A relative receiving delay time counter 619 computes relative delay time in receiving signals by using a shaped pulse signal transmitted from the pulse shaper 618 and a shaped pulse signal transmitted from the secondary stations 10.

A processor 610 computes time-based location information and speed information of the vehicle having the terminal 15 by using the relative receiving delay time which is measured by the relative receiving delay time counter 619 and transmits them to the traffic light controller 12.

Meanwhile, as illustrated in FIG. 6, a synchronous channel and a channel assignment channel are discriminated by Walsh codes, and the primary station 11 transmits the ID of the primary station through the synchronous channel and transmits channel assignment information and channel release information through the channel assignment channel.

Also, channel access information is received from the terminal 15 installed in the vehicle through the channel access channel, and ranging information and channel release confirming information are received through a ranging channel.

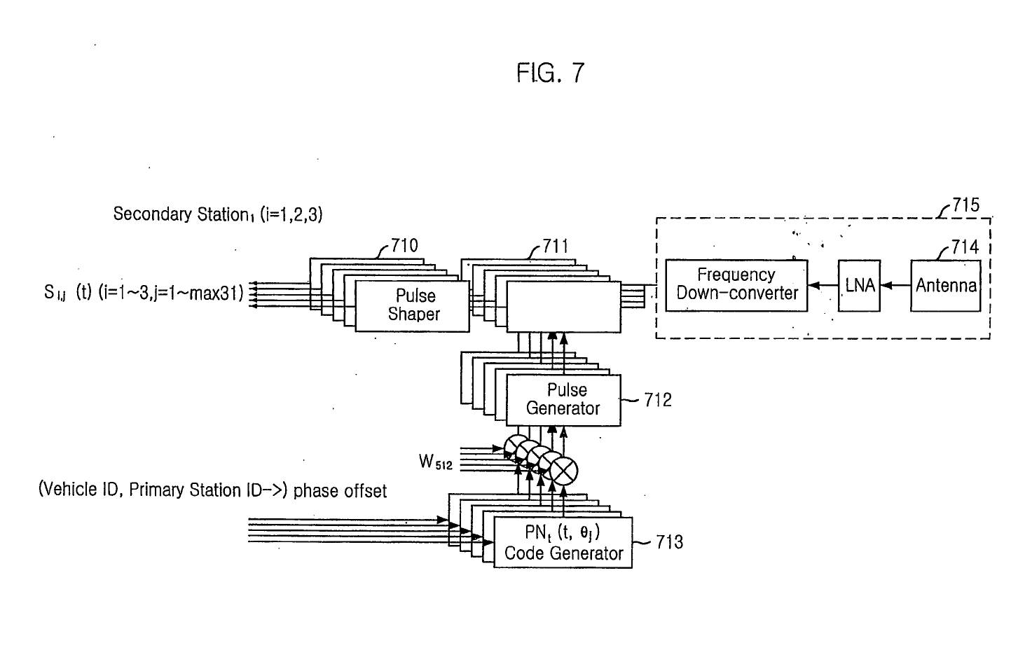

FIG. 7 is a block diagram showing a secondary station in accordance with an embodiment of the present invention.

As shown in FIG. 7, a secondary station of the present invention includes a ranging information receiving unit 715, a PNₜ(t, θⱼ) code generator 713, a pulse generator 712, a time integration correlator 711, and a pulse shaper 710. The ranging information receiving unit 715 receives ranging information (vehicle ID, channel No., and wake-up mode) which is spread by a PNₜ code (or a repeated short PNₜ code) which is obtained by performing phase offset based on the IDs of the primary station 11 and the vehicle and a Walsh code W₅₁₂, from the terminal 15 installed in the vehicle in 1 time slot. The PNₜ(t, θⱼ) code generator 713 performs phase offset by using the ID of the primary station. The pulse generator 712 generates pulse signals by using output signals of the PNₜ(t, θⱼ) code generator 713 and Walsh codes W₅₁₂. The time integration correlator 711 performs correlation on the received signals and the signals generated by the pulse generator 712. The pulse shaper 710 generates a pulse signal S_{i,j}(t) by extracting the maximum output of the time integration correlator 711.

Here, the ranging information receiving unit 715 includes an antenna 714 and, desirably, the antenna 714 should be a directional antenna.

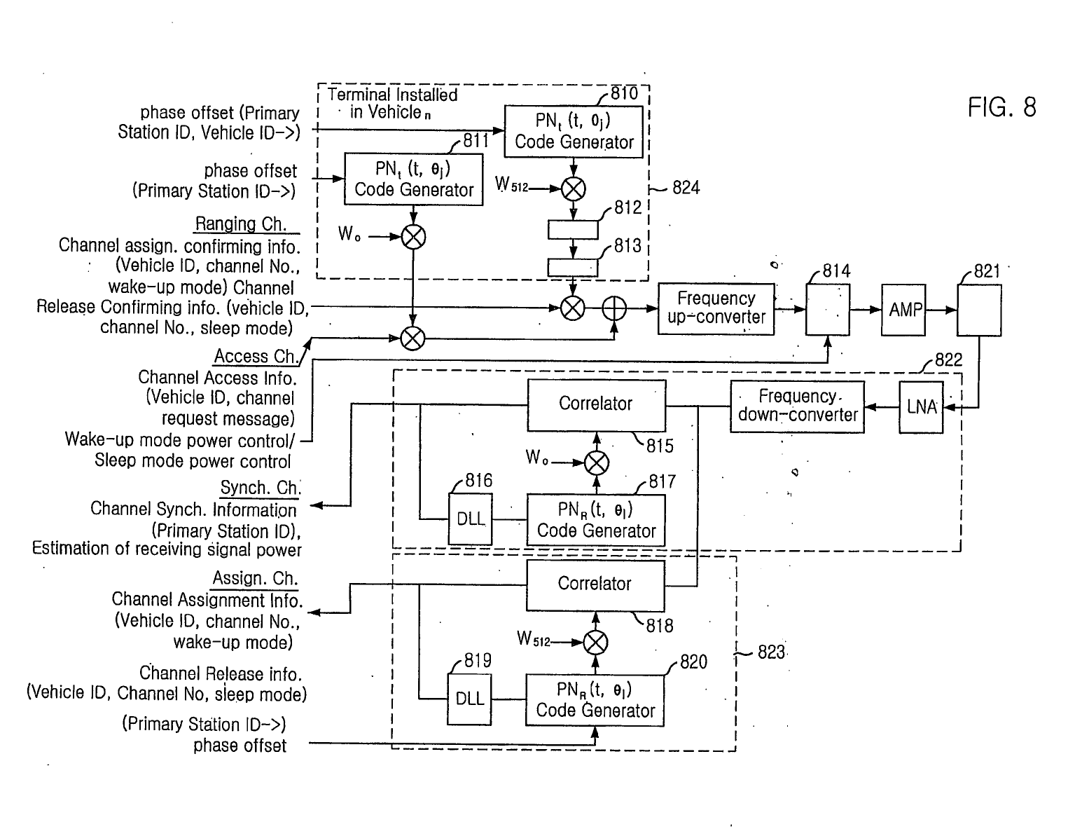

FIG. 8 is a block diagram showing a terminal installed in a vehicle in accordance with an embodiment of the present invention.

As shown in FIG. 8, the terminal 15 installed in the vehicle of the present invention includes following elements.

First, the synchronous information receiving unit 822 receives channel synchronization information (the ID of the primary station 11) which is spread by a PN_{R} code (or a repeated short PN_{R} code) which is obtained by performing phase offset based on the ID of the primary station 11 and a Walsh code W₀, from the primary station 11 in 1 time slot.

Here, a correlator 815, a delay lock loop (DLL) 816, and a PN_{R}(t, θ₁) code generator 817 are synchronized in accordance with the received code PN_{R}.

A channel assignment information receiving unit 823 receives channel revocation information (vehicle ID, channel No., and sleep/wake-up mode) which is spread by a PN_{R} code (or a repeated short PN_{R} code) which is obtained by performing phase offset based on the ID of the primary station 11 and a Walsh code W₅₁₂ from the primary station 11 in 1 time slot.

Here, a correlator 818, a DLL 819, and a PN_{R}(t, θ₁) code generator 820 are synchronized in accordance with the received code PN_{R}. The PN_{R}(t, θ₁) code generator 820 is initialized by using the ID of the primary station.

An information transmitting unit 824 transmits channel access information (Vehicle ID and channel request message) which is spread by a PNₜ code (or a repeated short PNₜ code) which is obtained by performing phase offset based on the ID of the primary station 11 and a Walsh code W₀, to the primary station 11 in 1 time slot.

Also, it transmits ranging information (Vehicle ID, channel No., and wake-up mode) which is spread by a PNₜ code (or a repeated short PNₜ code) which is obtained by performing phase offset based on the IDs of the primary station 11 and the vehicle, and a Walsh code W₅₁₂, to the primary station 11 and the secondary stations 10 in 1 time slot.

Further, it transmits channel release confirming information (Vehicle ID channel No., and sleep mode) which is spread by a PNₜ code (or a repeated short PNₜ code) which is obtained by performing phase offset based on the IDs of the primary station 11 and the vehicle, and a Walsh code W₅₁₂, to the primary station 11 in 1 time slot.

Here, during the transmission of channel access information, the PNₜ(t, θⱼ) code generator 811 generates a spreading code PNₜ which is phase-offset by the ID of the primary station 11 (or which is obtained by repeating a code length 31 33-times), and the PNₜ(t, θⱼ) code generator 810 generates a spreading code PNₜ which is phase-offset by the IDS of the primary station 11 and the vehicle (or which is obtained by repeating a code length 31 33-times) during the transmission of ranging information and channel release confirming information.

A pulse generator 812 generates a signal P_{P} illustrated in FIG. 4 based on a received code PNₜ, and an impulse generator 813 generates impulse signals P_{I} illustrated in FIG. 4 based on the signal generated by the pulse generator 812.

Also, the gain controller 814 minimizes interference on other adjacent systems. That is, in a case of a wake-up mode, it measures the power of a signal transmitted from the primary station 11 through the synchronization channel and minimizes the power of a transmitting signal to the primary station 11 based on the measured receiving signal power. In a case of a sleep mode, it controls power to release a ranging channel as it transmits channel release confirming information to the primary station 11.

Meanwhile, it is desirable that the antenna 821 is a directional antenna.

FIG. 9 is a diagram illustrating a structure of a Time Division Multiple Access (TDMA) channel in accordance with an embodiment of the present invention. It shows a structure of a Time Division Multiple Access (TDMA) and Time Division Duplex (TDD) channel that can minimize the influence on other adjacent systems and allow the primary station to accommodate sufficient number of vehicle stations, i.e., a maximum of 1024 vehicle stations.

As described in FIG. 9, a 1 time slot 915 is formed of a downlink slot 913 and an uplink slot 914. The downlink slot 913 adopts a CDMA method in which one bit of each of channel synchronization information or channel assignment information is spread by a Walsh code and a long code (or a repeated short code generated by repeating a code length 31 33-times). The uplink slot 914 adopts a CDMA method in which one bit of each of channel access information and ranging information by a Walsh code and a long code (or a repeated short code generated by repeating a code length 31 33-times).

Here, the 1 time slot 915, a 1 epoch 912 and a 1 packet time 911 are shared by a maximum of 31 terminals installed in vehicles in the CDMA method. One era 910 is divided into 32 packet times and shared by a maximum of 1024 terminals installed in vehicles in the TDMA method.

The method of the present invention can collect highly precise traffic information from the terminals installed in vehicles on a road by utilizing ultra wideband impulse signals.

In addition, the method of the present invention, which controls traffic lights based on the highly precise traffic information collected from the terminals installed in vehicles on the road-by using wideband impulse signals, can reduce costs for traffic congestion and logistics, help build roads and bridges economically through statistic analysis of traffic, cope with diverse types of traffic accident quickly, reduce personnel expenses by automatizing the management of traffic flow and parking, cut down on cost for fuel through smooth traffic flow, and reduce the extent of environmental pollution.

While the present invention has been described with respect to certain preferred embodiments, it will be apparent to those skilled in the art that various changes and modifications may be made without departing from the scope of the invention as defined in the following claims.

What is claimed is:

1. An apparatus for collecting/managing traffic information by using ultra wideband impulse, comprising:
a primary wireless communication means for assigning channels upon a channel assignment request from a terminal installed in a vehicle, computing location information and speed information, which will be referred to as traffic information, based on time by using a ultra wideband impulse response signal which is transmitted from the terminal installed in the vehicle and ultra wideband impulse response signals which are transmitted from a plurality of secondary wireless communication means, and transmitting the computed traffic information to a traffic control server;
the multiple number of secondary wireless communication means for transmitting the ultra wideband impulse response signals, which are transmitted from the terminal installed in the vehicle, to the primary wireless communication means; and
the traffic control server for managing the traffic information transmitted from the primary wireless communication means in a database so that the traffic information can be applied to traffic-related systems.

2. The apparatus as recited in claim 1, wherein the terminal installed in the vehicle controls power of a transmitting signal by measuring the intensity of a signal transmitted from the primary wireless communication means to minimize interference on adjacent systems, and release the assigned channels upon a channel release request from the primary wireless communication means.

3. The apparatus as recited in claim 1, wherein the primary wireless communication means, the multiple number of secondary wireless communication means, and the terminal installed in the vehicle utilize a directional antenna to minimize the interference on the adjacent systems.

4. The apparatus as recited in claim 1, wherein the primary wireless communication means, the multiple number of secondary wireless communication means, and the terminal installed in the vehicle transmit/receive signals through a synchronization channel, an access channel, an assignment channel and a ranging channel.

5. The apparatus as recited in claim 1, wherein the primary wireless communication means uses a combination method of Code Division Multiple Access (CDMA), Time Division Multiple Access (TDMA), and Time Division Duplex (TDD) to maximize the number of vehicles that can be accommodated within a communication coverage.

6. A system for controlling traffic lights by using traffic information, comprising:
a primary wireless communication means for assigning channels upon a channel assignment request from a terminal installed in a vehicle, computing location information and speed information, which will be referred to as traffic information, based on time by using a ultra wideband impulse response signal which is transmitted from the terminal installed in the vehicle and wideband impulse response signals which are transmitted from a plurality of secondary wireless communication means, and transmitting the computed traffic information to a traffic control means;
the multiple number of secondary wireless communication means for transmitting the ultra wideband impulse response signals, which are received from the terminal installed in the vehicle, to the primary wireless communication means; and
the traffic control means for controlling a traffic light based on the traffic information transmitted from the primary wireless communication means.

7. The system as recited in claim 6, further comprising a traffic control server for managing the traffic information transmitted from the primary wireless communication means in a database so that the traffic information can be applied to traffic-related systems.

8. The system as recited in claim 6, where the primary wireless communication means and the three secondary wireless communication means establish a predetermined communication are to reduce complexity of the traffic light control system and communicate with a vehicle entering a coverage independently.

9. A method for collecting/managing traffic information by using ultra wideband impulse, comprising the steps of:
assigning channels upon a channel assignment request from a terminal installed in a vehicle;
receiving a ultra wideband impulse response signal from the terminal installed in the vehicle;
computing location information and speed information, which will be referred to as traffic information, based on time by using the ultra wideband impulse response signal; and
managing the traffic information in a database so that the traffic information can be applied to traffic-related systems.

10. The method as recited in claim 9, wherein power of a transmitting signal is adjusted by measuring the intensity of a signal transmitted from the primary wireless communication means to minimize interference on adjacent systems in the step of transmitting the ultra wideband impulse response signal of the terminal installed in the vehicle.

11. The method as recited in claim 9, further comprising the step of:
releasing the assigned channels upon receipt of a channel release request transmitted from the primary wireless communication means to the terminal installed in the vehicle.

12. A method for controlling traffic lights using traffic information, comprising the steps of:
assigning channels upon receipt of a channel assignment request from a terminal installed in a vehicle;
receiving a ultra wideband impulse response signal from the terminal installed in the vehicle;
computing location information and speed information, which will be referred to as traffic information, based on time by using the ultra wideband impulse response signal; and
controlling traffic lights by using the traffic information.

13. The method as recited in claim 12, wherein the traffic information is managed in a database so that the traffic information can be applied to traffic-related systems.
